(19) United States
(12) Patent Application Publication
(10) Pub. No.: US 2002/0170366 A1
(43) Pub. Date: Nov. 21, 2002

(54) Ratchet tool test device

(76) Inventor: Hsiu-Ching Huang, Taipei City (TW)

Correspondence Address: CHARLES E. BAXLEY, ESQUIRE, Hart, Baxley, Daniels & Holton, 59 John St. 5 Fl., New York, NY, 10038, US

(21) Appl. No.: 09/859,556

(22) Filed: May 18, 2001

(51) Int. Cl. B25B 13/46

(52) U.S. Cl. 73/865.9; 434/401

(57) ABSTRACT

A ratchet tool test device includes a board having a hole and a recess which has a toothed inner periphery and shares a common axis with the hole. A pawl member has a shank rotatably extending through the hole and a plurality of extensions extend from the shank. Each of the extensions has teeth which are engaged with the toothed inner periphery. An engaging section is securely connected to the shank so as to be cooperated with a ratchet tool. When the ratchet tool is rotated, the teeth are moved over the toothed inner periphery in one direction.

### FIELD OF THE INVENTION

The present invention relates to a test device for testing rotation of a ratchet tool and the test device can be hanged on a wall for convenience for the consumers to test their ratchet tools.

### BACKGROUND OF THE, INVENTION

When purchasing a ratchet tool, the ratchet tool is simply packed in a package which as a transparent cover so that the buyers may check the ratchet tool. However, the buyers cannot practice the ratchet tool to check out what kind of situations will be or what is the feel of the operation of the ratchet mechanism of the ratchet tool. Is the ratchet tool operated in silence or noisy, or how tight the ratchet tool is rotated when mounting on an object?

The present invention intends to provide a ratchet tool test device which has a protrusion for being engaged with the ratchet tool. When rotating the ratchet tool, the protrusion is cooperated with a pawl member which is engaged with a toothed inner periphery and the protrusion can only be rotated in one direction.

### SUMMARY OF THE INVENTION

In accordance with one aspect of the present invention, there is provided a ratchet tool test device and comprises a board having a hole defined therethrough and a recess is defined in the board. The recess shares a common axis with the hole and has a toothed inner periphery. A pawl member has a shank rotatably extending through the hole and a plurality of extensions extend from the shank. Each of the extensions has teeth which are engaged with the toothed inner periphery. The teeth are shaped to allow the teeth to be rotated over the toothed inner periphery in one direction. An engaging section is securely connected to the shank and is engaged with a ratchet tool.

The primary object of the present invention is to provide a ratchet tool test device that provides an object for the ratchet tool to rotate.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a ratchet tool test device of the present invention;

FIG. 2 is a perspective view to show the ratchet tool test device of the present invention;

FIG. 3 is a perspective view to show the ratchet tool test device of the present invention and a ratchet tool is engaged with the engaging section of the test device, and

FIG. 4 is an illustrative view to show the extensions of the pawl member of the test device move over the toothed inner periphery in the board.

### DETAILED DESCRIPTION OF THE PREFERRED EMBODIMENT

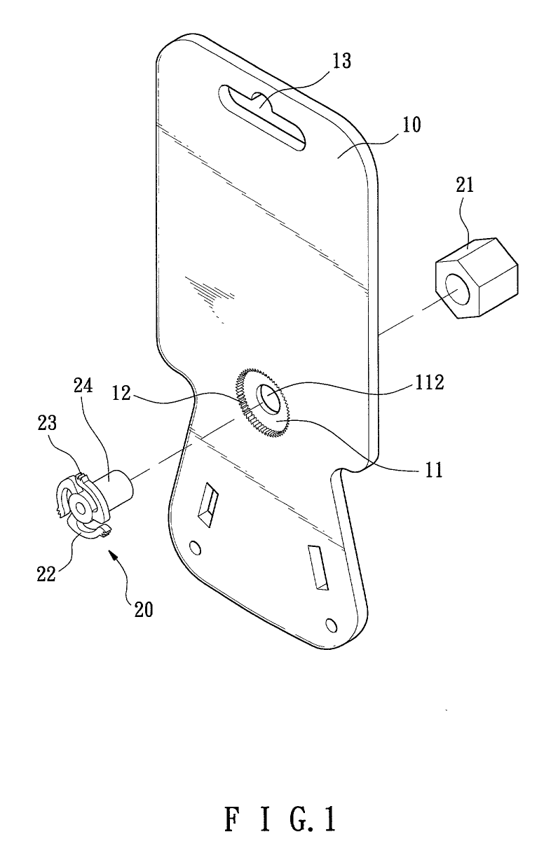

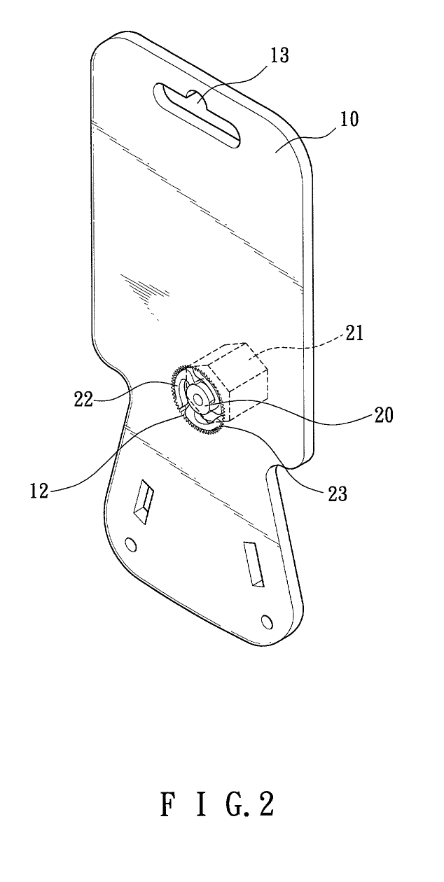

Referring to FIGS. 1 and 2, the ratchet tool test device of the present invention comprises a board 10 having a hole 112 defined therethrough and a recess 11 is defined in the board 10. The recess 11 shares a common axis with the hole 112 and has a toothed inner periphery 12. A slot 13 is defined through the board 10 as that the board 10 is able to be hanged on a wall.

A pawl member 20 has a shank 24 which rotatably extends through the hole 112 and a plurality of extensions 22 extend from the shank 24. Each of the extensions 22 has a free end and a gap is defined between each of the free ends of the extensions 22 and the shank 24. In other words, the extensions 22 have a proper flexibility and the free ends are allowed to be slightly moved toward the shank 24. Each of the free ends of the extensions has teeth 23 which are engaged with the toothed inner periphery 12. The teeth 23 are shaped so that the teeth 23 can only be rotated over the toothed inner periphery 12 in one direction. An engaging section 21 is securely connected to the shank 24 and has a polygonal outer periphery.

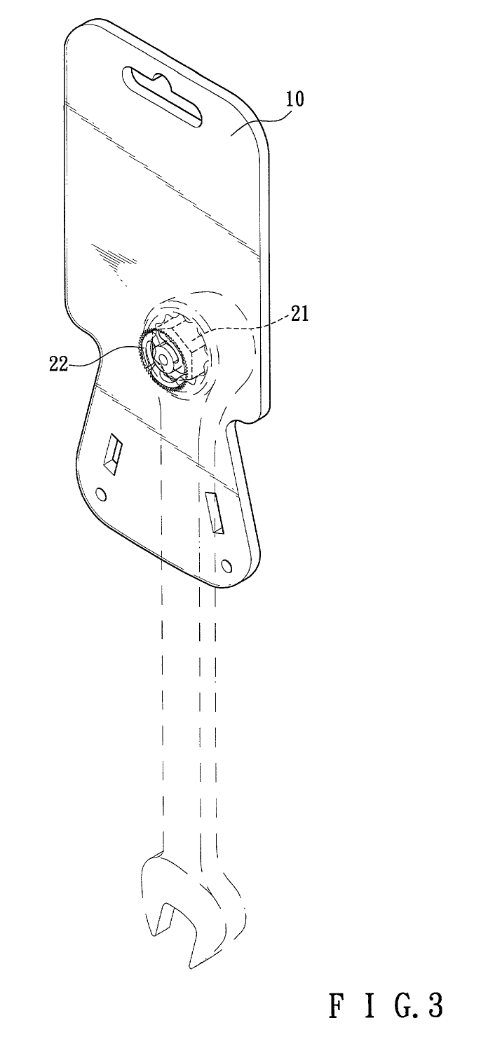

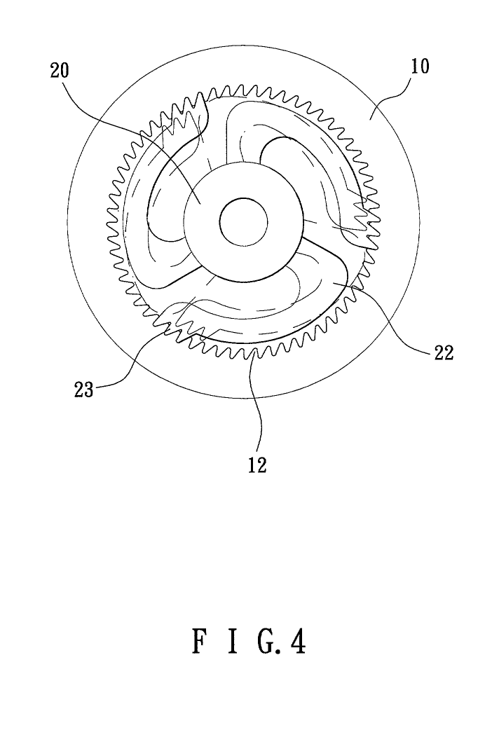

Referring to FIGS. 3 and 4, a ratchet tool can be engaged with the engaging section 21 and when rotating the ratchet tool, the pawl member 20 are rotated in one direction, the teeth 23 move over the toothed inner periphery 12 and produce sound like “click”. The ratchet tool cannot be rotated in an opposite direction because the shape of the teeth 23 cannot move over the toothed inner periphery 12.

The test device provides the engaging section 21 so that the customers can practice their ratchet tools and know how the products operate. The shape of the engaging section 21 can be various so as to be cooperated with different types of ratchet tools. The engaging section 21 may also has a slot or a Phillips groove for being cooperated with different bits.

While we have shown and described the embodiment in accordance with the present invention, it should be clear to those skilled in the art that further embodiments may be made without departing from the scope of the present invention.

What is claimed is:

1. A ratchet tool test device comprising:
a board having a hole defined therethrough and a recess defined in said board, said recess sharing a common axis with said hole and having a toothed inner periphery;
a pawl member having a shank which rotatably extends through said hole and a plurality of extensions extending from said shank, each of said extensions having teeth which are engaged with said toothed inner periphery, said teeth being shaped to allow said teeth to be rotated over said toothed inner periphery in one direction, and
an engaging section securely connected to said shank.

2. The device as claimed in claim 1, wherein each of said extensions having a free end and a gap is defined between each of said free ends of said extensions and said shank, said teeth defined in said respective free ends.

3. The device as claimed in claim 1, wherein said engaging section has a polygonal outer periphery.
